(19) United States
(12) Patent Application Publication
(10) Pub. No.: US 2009/0327377 A1
(43) Pub. Date: Dec. 31, 2009

(54) Copying entire subgraphs of objects without traversing individual objects

(75) Inventor: Tatu J. Ylonen, Espoo (FI)

Correspondence Address: TATU YLONEN OY, LTD., KUTOJANTIE 3, ESPOO, 02630, FI

(73) Assignee: Tatu Ylonen Oy Ltd, Espoo (FI)

(21) Appl. No.: 12/489,617

(22) Filed: Jun. 23, 2009

Related U.S. Application Data
(63) Continuation-in-part of application No. 12/147,419, filed on Jun. 26, 2008.
Application No. 12/147,419 is a continuation-in-part of application No. 12/432,779, filed on Apr. 30, 2009.

(51) Int. Cl. G06F 12/00; G06F 12/08; G06F 17/30

(52) U.S. Cl. 707/206; 711/141; 711/162; 707/E17.044; 711/E12.001; 711/E12.002; 711/E12.009

(57) ABSTRACT

Copying or compacting performance in garbage collection is improved by copying a first memory area (preferably comprising multiple objects) to a second memory area without traversing individual objects in the copied memory area and adjusting all copied memory locations identified as pointers in a metadata data structure. An entire linearized subgraph of the object graph can be copied at a time.

### CROSS-REFERENCE TO RELATED APPLICATIONS

This application is a continuation-in-part of U.S. patent application Ser. No. 12/147,419, filed Jun. 26, 2008 (pending), which is hereby incorporated herein by reference.

This application is a continuation-in-part of U.S. patent application Ser. No. 12/432,779, filed Apr. 30, 2009 (pending), which is hereby incorporated herein by reference.

### INCORPORATION-BY-REFERENCE OF MATERIAL SUBMITTED ON ATTACHED MEDIA

Not Applicable

### TECHNICAL FIELD

The invention relates to automatic memory management in general, and particularly to garbage collection techniques in computer systems.

### BACKGROUND OF THE INVENTION

General information about garbage collection, including an extensive survey of various garbage collection methods, can be found in the book R. Jones and R. Lins: Garbage Collection: Algorithms for Dynamic Memory Management, Wiley, 1996, which is hereby incorporated herein by reference.

As computer memory sizes and applications grow, and increasingly many server applications utilize garbage collection, the efficiency of garbage collection for long-lived objects becomes increasingly important. Several solutions have been developed for overall speeding up garbage collection and reducing pause times in such environments, including, e.g., the Train collector (Hudson & Moss: Incremental collection of mature objects, IWMM'92, ACM, 1992) and the Garbage-First garbage collector (Detlefs et al: Garbage-First Garbage Collection, ISMM'04, pp. 37-48, ACM, 2004). These references are hereby incorporated herein by reference.

Much of the work on speeding up garbage collection for old objects has focused on partitioning the memory so that not everything needs to be collected at once, reducing the frequency of collecting memory regions that are unlikely to contain a lot of garbage, moving some of the work from garbage collection to be performed during mutator execution, and using many threads to traverse (trace) and copy the object graph in parallel (e.g., using atomic operations to install forwarding pointers, or partitioning the memory area being garbage collected so that each thread operates on a separate subarea).

Garbage collection in modern systems is an ongoing process or activity, typically comprising periodic evacuation pauses that each collect some garbage. In some systems garbage collection runs at least partially concurrently with normal application programs.

Many data processing applications represent data in the form of objects. Each object is stored in one or more memory locations. In many systems objects are represented using cells (typically 32, 64, or 128 bits each), whose type may be known (e.g., determined by the compiler) or whose type may be encoded, for example, in the cell itself (e.g., using tag bits stored in the high-order or low-order bits of each cell, or both), in its address, or in the object pointed to by a pointer in the cell (in a field in an object header). These methods of encoding the object's type may also be combined. Some systems also attach special type descriptors to some of the objects.

The contents of the memory of an application can be viewed as a graph, whose vertices are the objects and whose edges are the pointers between objects.

Applications typically have a (dynamically changing) set of memory locations that are considered intrinsically live (i.e., potentially accessible to the application). Typically such memory locations are called roots (not to be confused with roots of trees or multiobjects), and include, e.g., global variables, stack slots, and/or processor or virtual machine registers. Garbage collectors generally try to determine which objects are live, i.e., reachable from at least one of the roots.

The term “object” as used in this disclosure is not limited to classes, their instances or structures; it also includes, for example, numbers, arrays, strings, hash tables, characters, Lisp-like pairs, Lisp-like symbols, and other data values. Some objects reference other objects using pointers.

In this disclosure, the term “pointer” (or “reference”) is intended to mean any kind of reference between objects, without restricting it to an actual memory address. The pointer could also comprise tag bits to indicate the type of the pointed object, or it could be divided into several fields, some of which could, e.g., include security-related or capability information (as described in Bishop) or a node or area number plus object index. It is also possible to have several types of pointers, some direct memory addresses (possibly tagged), some going through an indirection data structure, such as an indirection vector, indirection hash table, or the remembered set data structure (as with inter-area links in Bishop). A pointer might also refer to a surrogate or stub/scion in a distributed system, or might be the identifier of a persistent object in a persistent object store. A pointer may also comprise an identifier (e.g., index) for a memory area plus an offset or sub-identifier into the memory area identifying an object stored therein.

Pointer swizzling is a technique related to changing a pointer to another type of pointer (e.g., other encoding). Most commonly it is used to convert between direct pointers (memory addresses, possibly with tags) and persistent or global object identifiers. Various approaches to pointer swizzling (and unswizzling) are described in P. Wilson: Pointer Swizzling at Page Fault Time: Efficiently Supporting Huge Address Spaces on Standard Hardware, ACM SIGARCH Computer Architecture News, 19(4):6-13, 1991 and A. Kemper et al: Adaptable Pointer Swizzling Strategies in Object Bases: Design, Realization, and Quantitative Analysis, VLDB Journal, 4(3):519-566, 1995; these are hereby incorporated herein by reference.

Various cache coherency protocols are described in J. Handy: The Cache Memory Book, Academic Press, 1998; M. Tomasevic et al: The Cache Coherency Problem in Shared-Memory Multiprocessors: Hardware Solutions, IEEE Computer Society Press, 1993; and I. Tartalja et al: The Cache Coherency Problem in Shared-Memory Multiprocessors: Software Solutions, IEEE Computer Society Press, 1996. These books are hereby incorporated herein by reference.

### BRIEF SUMMARY OF THE INVENTION

Garbage collection performance is improved by copying a subgraph of the full object graph using a simple memory copy operation (such as the memcpy( ) function in C or, e.g., DMA-based hardware copying), and using information about which memory locations (offsets) in the subgraph comprise pointers to other objects within the same copied subgraph to adjust internal pointers without needing to traverse objects in the subgraph. Preferably the subgraph is stored in memory as a single contiguous memory area, and the internal pointers are adjusted by adding the difference of the new starting address and the old starting address of the subgraph to each internal pointer. Pointers from outside the subgraph to objects in the subgraph (i.e., external pointers) can be adjusted by adding the same difference to each such pointer (or, e.g., if the pointer is to the first memory location of the subgraph, writing the new starting address to the pointer, and otherwise writing the new starting address plus the offset of the referred object in the subgraph to the referring location).

The most general form of the invention provides a way of copying a memory area and adjusting copied memory locations identified as pointers in a metadata data structure. In such form, the invention could be implemented, e.g., in ASICs or processors with built-in support for high-performance garbage collection.

A first aspect of the invention is a pointer-adjusting data copying method comprising:
copying, by a data processing device, a first memory area to a second memory area; and
adjusting at least one copied memory location identified as a pointer in a metadata data structure.

A second aspect of the invention is a data processing device comprising:
a pointer adjusting memory copier, wherein the memory copier:
   copies a first memory area to a second memory area; and
   adjusts at least one copied memory location identified as a pointer in a metadata data structure.

A third aspect of the invention is a computer program product stored on a tangible computer-usable medium, operable to cause a data processing device to:
participate in garbage collection;
copy a first memory area to a second memory area as part of such garbage collection; and
adjust at least one copied memory location identified as a pointer in a metadata data structure.

In many advantageous embodiments of each of the various aspects of the invention,
the first memory area comprises an essentially contiguous distinguished subgraph comprising more than one object;
the pointers identified in the metadata data structure are the internal pointers of the distinguished subgraph; and
the copying is performed without traversing individual objects in the distinguished subgraph.

The potential benefits of the present invention include, but are not limited to improving garbage collection performance (particularly for objects in non-nursery generations or a mature object space), reducing power consumption in mobile devices employing garbage collection, assisting clustering, distribution, caching, persistence, and prefetching (especially in distributed and persistent object systems), and improving the performance of processors and other microchips in garbage collection.

### BRIEF DESCRIPTION OF THE SEVERAL VIEWS OF THE DRAWING(S)

FIG. 1 illustrates a computing device.

FIG. 2 illustrates a clustered computing system.

FIG. 3 illustrates a garbage collector in a virtual machine.

FIG. 4 illustrates how memory address space can be arranged in some advantageous embodiments of the invention.

FIG. 5 illustrates grouping objects into subgraphs (in this case, into tree-like subgraphs).

FIG. 6 illustrates an object graph divided into subgraphs that are each stored contiguously in memory (in this case, into tree-like subgraphs).

FIG. 7 illustrates how metadata can be maintained for subgraphs in some embodiments of the invention, tracking references between subgraphs.

FIG. 8 illustrates a tree-like subgraph stored in contiguous memory, with a bitmap of metadata stored with it.

FIG. 9 illustrates copying a subgraph using memcpy and updating its internal pointers and external pointers referencing objects in it.

FIG. 10 illustrates a top-level multiobject with several subordinate multiobjects and holes (free space).

FIG. 11 illustrates an embodiment of a data processing device according to the present invention.

### DETAILED DESCRIPTION OF THE INVENTION

A distinguished subgraph is defined as a subgraph of the object graph stored in a data processing device, where the distinguished subgraph has a distinguished identity as a whole. Having a distinguished identity means that there is some identifier or metadata for the group as a whole. The identifier may be, e.g., a pointer, an index into an array of descriptors, a separately allocated identifier, a persistent object identifier, or a global object identifier in a distributed system. A distinguished subgraph may in some embodiments comprise smaller distinguished subgraphs (that is, in some embodiments they may be nested).

A distinguished subgraph is further constrained to be stored in an essentially contiguous memory address range. Essentially contiguous means herein that there may be padding, metadata, or holes in the memory address range, but otherwise it would be contiguous (such holes could be created, e.g., by writes to objects in the subgraph rendering parts of the subgraph unreachable from the other objects). The graph is said to be linearized, i.e., stored in a linear range of memory addresses that are essentially contiguous.

Objects in a distinguished subgraph may reference other objects (or themselves) using pointers. Pointers that reference objects in the same distinguished subgraph are called internal pointers. Pointers that reference objects in other distinguished subgraphs are called external pointers. (Pointers that reference objects in nested distinguished subgraphs may be considered either, depending on the particular embodiment.)

In the preferred embodiment many distinguished subgraphs comprise more than one object, and each distinguished subgraph is at least weakly connected (that is, taking only the subgraph and replacing the directed edges (pointers) by undirected edges, the resulting undirected graph would be connected, i.e., there would be a path between any two nodes in the graph).

In practice a distinguished subgraph usually is a subset of the nodes (objects) in the object graph plus all pointers (edges) between the nodes in the subset, because it is not possible to arbitrarily remove edges (pointers in objects) in most garbage collection applications. However, theoretically one could treat some or all of the internal pointers similarly to external pointers, with some extra overhead.

An example of a distinguished subgraph is a multiobject, defined as a tree of objects having independent identity as a whole and stored in an essentially contiguous memory address range. However, distinguished subgraphs are not constrained to have a tree-like structure and are not constrained to have only one object (the root) referenced from outside the multiobject. In some embodiments a more liberal structure may be used for multiobjects. For example, writes to within a multiobject may render parts of the multiobject unreachable, and added external references to objects within the multiobject may make it desirable to have nested multiobjects or entries pointing to within multiobjects.

Another example of a distinguished subgraph is a relaxed multiobject, defined as a (semi-)linearized graph of objects where the objects have been stored in a predefined (specific) order, where in some embodiments more liberal multiobject structures than a tree may be used and objects within the relaxed multiobject could be allowed to have more than one reference from within the same multiobject. Relaxed multiobjects are described in more detail in the U.S. patent application Ser. No. 12/432,779, which is incorporated herein by reference. (Semi-)linearized means linearized (into a predefined order) and essentially contiguous.

A further example of a distinguished subgraph is a subordinate multiobject, defined as a (relaxed) multiobject at least partially embedded within another multiobject (i.e., their address ranges overlap).

A distinguished subgraph is associated with metadata. Such metadata may follow or precede the objects of the distinguished subgraph in its essentially contiguous address range, or it may, e.g., be stored in or reachable from a separate metadata data structure reachable from the distinguished subgraph (e.g., using its identifier to index an array of descriptors, by following a pointer stored next to the objects, or by looking it up from a hash table based on its identifier).

The metadata is preferably a bitmap (803) (i.e., a bit vector, or array of bits), which specifies which cells of the multiobject contain internal pointers. This metadata is preferably initialized when the distinguished subgraph is first constructed, and may be updated if the structure of the multiobject later changes (e.g., because of merging or splitting distinguished subgraphs or because a write modifies an internal pointer). The bitmap could also comprise other data besides the internal pointer indicators, and could comprise more than one bit per cell. Instead of a bitmap, a hash table, array of indices or offsets, a linked list of indices or offsets, a tree, or any known representation for a set could be used.

A distinguished subgraph can be constructed from a set of objects by copying the objects into consecutive memory locations in some suitable order. The construction advantageously comprises dividing the object graph into subgraphs (for example, tree-like subgraphs, subgraphs having only one object referenced from outside the subgraph, or subgraphs that are strongly connected components—see Cormen et al: Introduction to Algorithms, 2nd ed., MIT Press, 2001), one of which is used for constructing the distinguished subgraph, allocating memory space for the distinguished subgraph, copying the objects belonging to the subgraph into the allocated memory space, and updating references to objects in the subgraph from outside the subgraph. A detailed description of the construction of multiobjects (tree-like distinguished subgraphs) can be found in the U.S. patent application Ser. No. 12/147,419, which is hereby incorporated herein by reference. The internal pointer bitmap can be most advantageously initialized in the copy_heap_cell( ) code snippet described therein, by adding a line at the end of that code snippet to compute the bit index corresponding to the ‘cellp’ value (e.g., as ‘((long)cellp−(long)range start_addr)/CELL_SIZE’), and if ‘cellp’ points to within the (new copy of the) distinguished subgraph, setting the corresponding bit in the internal pointer bitmap. Any method of traversing an object graph can be used while constructing a distinguished subgraph; many are described in Jones&Lins, and further advantageous methods are described in the U.S. patent application Ser. No. 12/394,194, which is hereby incorporated herein by reference.

When a distinguished subgraph is constructed, some kind of identifier and/or metadata is allocated for it. In many embodiments the metadata would comprise the set of addresses (or exit descriptors) referencing objects in the distinguished subgraph from outside it. It would also comprise an offset for each of the referenced objects in some embodiments. It would also typically comprise the starting address and size (or end address) of the address range in which the distinguished subgraph is currently stored. It may comprise the metadata identifying internal pointers.

The size of distinguished subgraphs may be limited when dividing the objects into subgraphs. Limiting the size allows fixed size stacks to be used in operations that traverse the objects in a distinguished subgraph.

Once distinguished subgraphs have been constructed, they may be moved or copied. A typical application of such copying (moving) is garbage collection of non-nursery generations or the mature object space. A related application is compaction in mark-and-sweep garbage collectors.

In some object database (or file-based storage) embodiments a distinguished subgraph serves as the unit that is read from or written to disk at a time, and adjusting internal pointers may be performed in two steps (partly during writing and partly during reading).

One possibility is to write the starting address of the distinguished subgraph together with the distinguished subgraph, and, when reading, add the difference of the new starting address (into which it is read) and the old saved starting address to internal pointers.

Another possibility is to adjust the internal pointers to be offsets relative to the start of the distinguished subgraph before writing, and add the starting address of the new memory area to internal pointers after reading the distinguished subgraph.

In some distributed system embodiments a distinguished subgraph is the unit of caching and a cache coherence protocol is used to marshall read and write access to at least some distinguished subgraphs. Many known cache coherency protocols for distributed systems can be used; one skilled in the art should be able to adapt a known cache coherency protocol to be used for distinguished subgraphs. A particularly simple protocol permits any number of nodes to keep a read-only copy of a distinguished subgraph, but when a node wants to write to a distinguished subgraph, it is invalidated from any other nodes before granting (exclusive) write access to the node that wants to write. Preferably the distinguished subgraph would then be committed to non-volatile storage before releasing the exclusive access and again allowing readers to obtain copies of the (modified) distinguished subgraph. Adjusting internal pointers in distributed systems could operate similarly to the object database case, with transmitting substituted for writing and receiving substituted for reading.

When a distinguished subgraph is to be copied, a second memory address range is allocated for it, and the distinguished subgraph is copied to that memory address range (preferably with its metadata).

In some embodiments of the present invention, a distinguished subgraph is copied to the second memory address range using a memory copy operation followed by updating internal pointers. A possible embodiment of this is illustrated by the code below (‘src’ is the old address of the distinguished subgraph, ‘dst’ the new address, ‘size’ its size in cells (words), ‘bitmap’ is a bitmap indicating which cells contain internal pointers, and pointer arithmetic is assumed to operate as in the C programming language):

```
simple_copy(dst, src, size, bitmap) {
  memcpy(dst, src, size * CELL_SIZE);
  for (i in bitmap where bitmap[i] == 1)
    dst[i] += (char *)dst − (char *)src;
}
```

The loop is intended to iterate over all those offsets that contain an internal pointer (here indicated by the corresponding bit in the bitmap being set). Naturally, the difference between ‘dst’ and ‘src’ could be computed once before the loop. Adjusting could also be done before copying in the source area, if it is not needed after copying. It could also be done in two steps, e.g., subtracting the ‘src’ address from the internal pointers before copying, and adding ‘dst’ after copying (where further these two references to copying may refer to separate instances of copying).

It is also possible to use a modified memory copy where the updating the internal pointers is interlaced with copying. The following code illustrates such copying (here it is assumed for simplicity that indexing a bitmap accesses a particular bit; a practical implementation might use shifting and masking, or a bit test instruction, and some processors provide an instruction for directly accessing bitmaps; also, in a practical implementation loop unrolling and/or vector operations (e.g., MMX or SSE instructions) could be used to micro-parallelize the loop; it might be advantageous to parallelize the loop so that each word in the bitmap is handled in parallel, or a full cache line in ‘src’ and/or ‘dst’ is handled in parallel).

```
simultaneous_adjust_copy(dst, src, size, bitmap) {
  delta = (char *)dst − (char *)src;
  for (i = 0; i < size; i = i + 1)
    if (bitmap[i] != 0)
      dst[i] = src[i] + delta;
    else
      dst[i] = src[i];
}
```

This approach is particularly well suited for hardware implementation. In hardware embodiments of the copying operation, the copying could be performed by a special circuit or module that operates similar to a DMA controller, except that it also reads the bitmap, and adds a specified value (the difference) to cells marked in the bitmap. One skilled in the art of VLSI design can easily see how the state machine of a known DMA controller would need to be modified to take the bitmap into account, as illustrated in the code snippet above; such modification could easily be accomplished by a relatively small change in the VHDL, Verilog, or similar description of the DMA controller from which the controller (or the processor, ASIC or other chip comprising it) is typically synthesized using automated tools. Possible hardware embodiments are not limited to those based on DMA controllers, but could also include, e.g., special instructions, microcode, or coprocessors.

The data processing device tracks which cells in a distinguished subgraph comprise internal pointers and identifies them in some suitable data structure, preferably a bitmap. This data structure is preferably initialized when the distinguished subgraph is constructed. If distinguished subgraphs are written and read to disk, the data structure may also be written and read to track which cells are internal pointers, or alternatively the distinguished subgraph may be traversed after reading it from disk to determine which cells in it are internal pointers and the data structure may be reconstructed based on the traversing. Similar considerations apply to sending and receiving distinguished subgraphs over a communications network in, e.g., a distributed object system.

Tracking the internal pointers usually means that the data structure identifying which cells are internal pointers is kept up to date. In some embodiments the data structure may be interpreted in combination with another data structure, such as a bitmap indicating which cells have been written, or it may be combined with another data structure. In embodiments where bits are available in cells, such as when all cells are tagged, as in some earlier Lisp machines, it is also possible to track which cells are internal pointers using a bit in each cell; then the tracking data structure is distributed in the cells (it could also be distributed based, e.g., on objects or pages, and the same data structure could be shared for many distinguished subgraphs, e.g. if a single bitmap was used to record the internal pointer bit for all cells in an independently collectable memory region). In some embodiments the data structure identifying which cells are internal pointers might be freed, e.g. if almost out of memory, and regenerated by traversing the distinguished subgraph(s), e.g. when memory is again available.

In many embodiments cells in the objects in a distinguished subgraph may be written after the distinguished subgraph is constructed. In many such embodiments, the internal pointer bit is preferably cleared when such a write occurs, at least if the new value points to outside the distinguished subgraph.

Such writes may also create holes in the distinguished subgraph, the holes containing objects that are no longer reachable. The creation of such holes for multiobjects (tree-like distinguished subgraphs) and the use of nested and zombie multiobjects is described in detail in the U.S. patent application Ser. Nos. 12/432,779 and 12/435,466, which are hereby incorporated herein by reference.

Holes can be removed from a distinguished subgraph during copying by allocating space for the distinguished subgraph without the holes (i.e., subtracting the size of the holes from its size), dividing the distinguished subgraph for copying purposes into sections delimited by one or more of the holes, and copying each section in turn into essentially consecutive addresses using code analogously to that illustrated above, with the ‘new’ pointer referring to the starting address of the address range into which that section is being copied, and ‘old’ referring to the old starting address of that section. The internal pointer bitmap (or other metadata used to track which cells contain internal pointers) would be copied or adjusted to delete the holes.

Two or more distinguished subgraphs can be combined (merged) by allocating space for their combined size, and treating each distinguished subgraph being combined similar to the sections above. The new internal pointer bitmap (or metadata) would then be constructed by concatenating the bitmaps for each of the distinguished subgraphs being combined, or by traversing. A person skilled in the art can also combine this with the hole removal described above.

When moving distinguished subgraphs, there is usually a need for updating pointers that reference objects within the distinguished subgraph. This generally requires keeping some kind of metadata about which addresses contain external pointers to within each distinguished subgraph. This is described in detail for multiobjects (tree-like distinguished subgraphs) in U.S. patent application Ser. No. 12/147,419, which is incorporated herein by reference. For general distinguished subgraphs, the referring pointer can be updated to the new address by adding ‘dst−src’ to it. When removing holes or combining distinguished subgraphs, the relevant section comprising the referenced object must first be determined, and the ‘src’ and ‘dst’ values for that section used. In some embodiments updating the referring pointer could involve pointer swizzling or unswizzling.

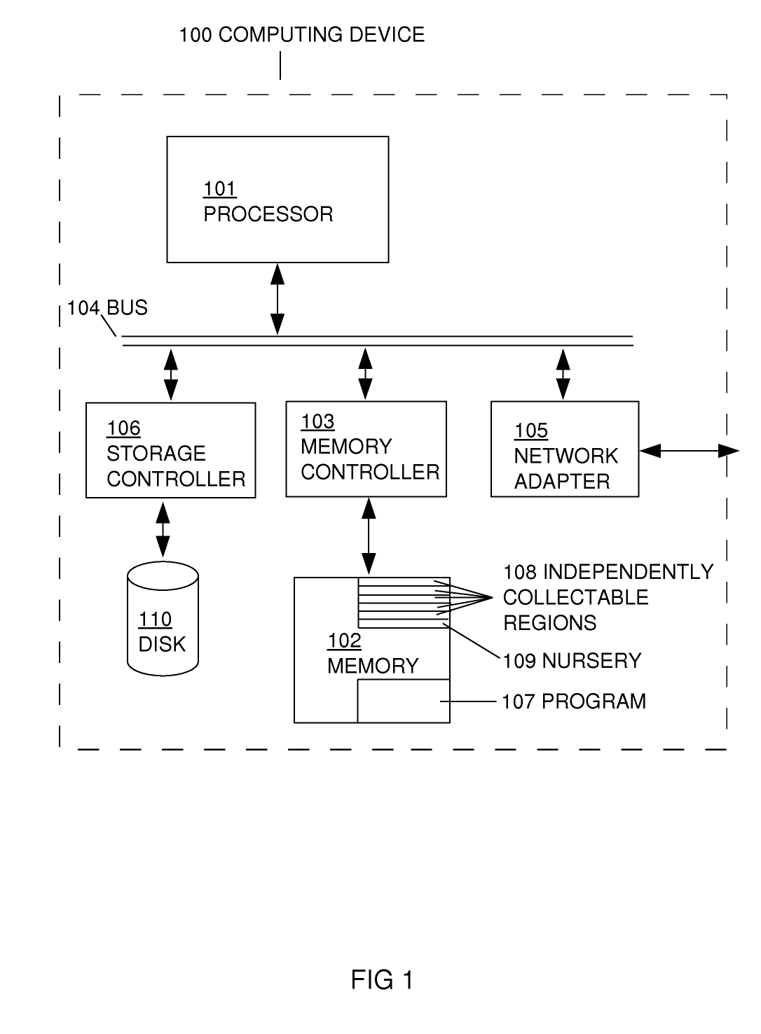

FIG. 1 is a schematic diagram of a computing device (100). A computing device is a data processing device that comprises at least one processor (101) (potentially several physical processors each comprising several processor cores), at least one main memory device (102) (possibly several memory devices logically operating together to form a single memory space where application programs cannot distinguish which memory location is served by which memory device(s)), at least one memory controller (103) (increasingly often integrated into the processor chip in modern high-end and embedded processors), an optional non-volatile storage controller (106) and associated non-volatile storage medium (110) such as magnetic disk memory, optical disk memory, semiconductor memory, or any other memory technology that may be developed in the future (including the possibility of supplying power to non-volatile memory chips for extended periods of time from, e.g., a battery to emulate non-volatile memory), an optional network adapter (105) for communicating with the world outside the computing device, a bus connecting the various components (104) (often actually several buses, some internal to each processor and some external). The memory (102) comprises a program (107) that can be executed by the processor(s) (101) as well as data areas including a young object area or nursery (109) and one or more independently collectable regions (108).

Even though today a computing system would be implemented using electronic circuitry (highly integrated in semiconductor chips), in the future other implementation technologies could be used, including but not limited to integrated optical circuitry, crystal-based or holographic memories, three-dimensional circuitry, printed electronics, nanotechnology-based circuitry, or quantum computing technology.

A data processing device comprises one or more memory devices, collectively called its memory. At least part of the memory is called its main memory; this is fast memory that is directly accessible to the processor(s). Some of the memory may be volatile (i.e., loses its contents when powered off), and some may be non-volatile or persistent (i.e., retains its contents when powered off). Memory devices connected through the I/O controller are typically non-volatile; the main memory is typically volatile, but may also be at least partially non-volatile in some data processing devices. Some data processing devices may also have access to memory that physically resides behind the network, such as in network file servers or in other nodes of a distributed object system. Such remote memory is considered equivalent to local memory for the purposes of this disclosure, as long as it is accessible to the data processing device (there is no fundamental difference between using the SCSI protocol to access a local disk and using the iSCSI protocol or NFS protocol to access a remote disk).

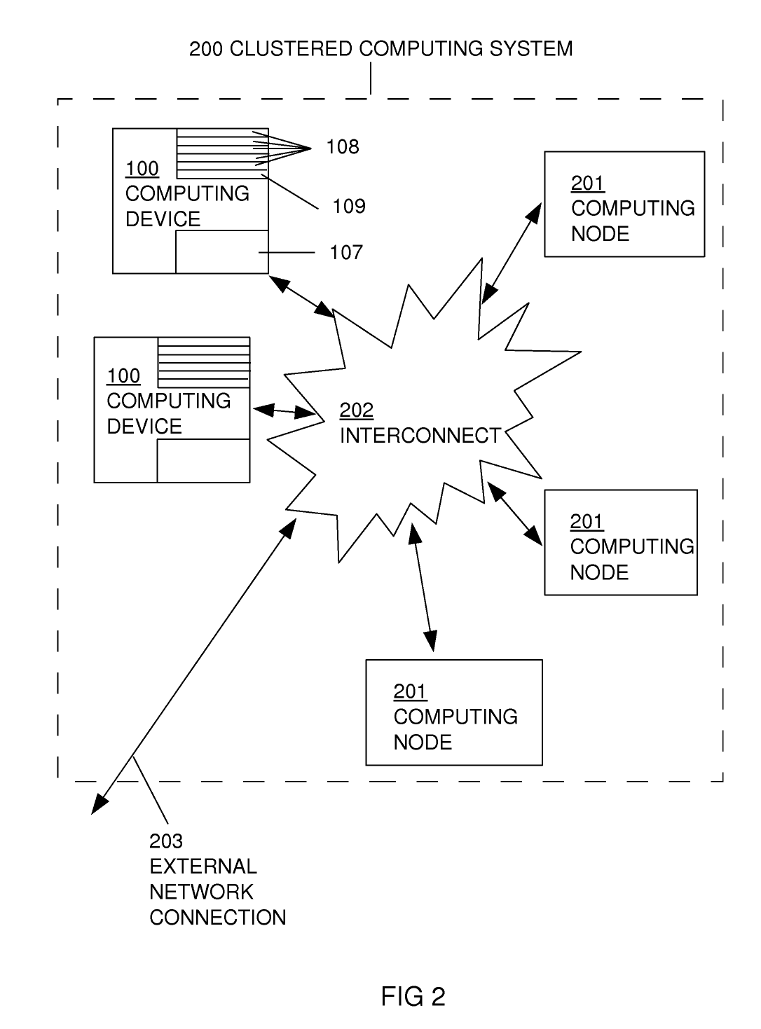

FIG. 2 is a schematic diagram of a clustered computing system (200), a data processing device that comprises one or more computing devices (100), any number of computing nodes (201) (each computing node comprising a processor (101), memory (102), memory controller (103), bus (104), network adapter (105), and usually a storage controller (106) and non-volatile storage (110)), an interconnection fabric (202), and an external network connection (203). The interconnect (202) is preferably a fast TCP/IP network (though other protocols can also be used, such as gigabit ethernet, ten gigabit ethernet, ATM, HIPPI, FDDI, Infiniband), using any network topology (including but not limited to star, hypercube, hierarchical topology, cluster of clusters, and clusters logically providing a single service but distributed to multiple geographical locations to implement some aspects of the service locally and others by performing parts of the computation at remote nodes). A clustered computing system (200) may have more than one connection to the external world (203), originating from one or more of the computing nodes or from the interconnection fabric, connecting the clustered computing system to the external world. In Internet-oriented applications, the external connection(s) would typically be the channel whereby the customers use the services offered by the clustered computing system. In addition to a data-oriented protocol, such as TCP/IP, the clustered computing system may also have voice-oriented external network connections (such as telecommunications interfaces at various capacities, voice-over-IP connections, ATM connections, or radio channels such as GSM, EDGE, 3G, or any other known digital radio protocols; it is anticipated that other protocols will be invented and deployed in the future). The same external network connections are also possible in the case of a single computing device (100).

In some embodiments entire clustered computing systems are integrated as single chips or modules (network processors and some specialized floating point processors are already taking this path).

It should also be understood that different levels of integration are possible in a computing system, and that the level of integration is likely to increase in the future. For example, many modern processors integrate the memory controller on the same chip with the processor cores in order to minimize memory latencies, and especially embedded processors already integrate some or all of the memory. Some systems, particularly mobile devices, utilize system-on-a-chip designs, where all components, including memory and communications, may be embedded on the same chip.

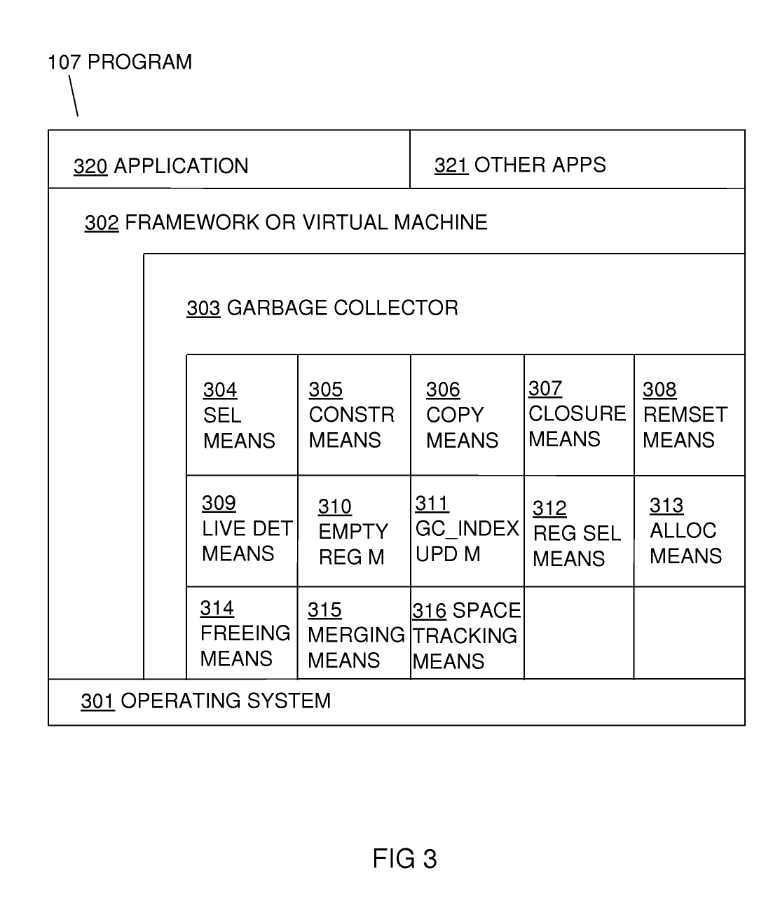

FIG. 3 is a schematic diagram of the programming of a computing device, including a garbage collector. The program (107) is stored in the tangible memory of the computing device (volatile or non-volatile, read-write or read-only), and usually comprises at least one application program element (320), usually several supporting applications (321) that may even be considered part of the operating system, usually an operating system (301), and some kind of run-time framework or virtual machine (302) for loading and executing programs. The framework or virtual machine element (which, depending on how it is implemented, could be considered part of the application (320), part of the operating system (301), or a separate application (321)), comprises a garbage collector component (303). The selection means (304) implements selecting some objects to be grouped together to form a distinguished subgraph with at least some distinguished subgraphs comprising multiple objects. The construction means (305) constructs distinguished subgraphs from live objects in the area currently designated as the nursery (109). The copy means (306) copies existing distinguished subgraphs as described in this specification. The closure means (307) computes the transitive closure of the reachability relation, preferably in parallel with mutator execution and evacuation pauses. The remembered set management means (308) manages remembered sets (information about external pointers), either exactly or using an approximate method (overgeneralizing the reachability graph), to compensate for changes in roots and writes to distinguished subgraphs or the nursery. The liveness detection means (309) refers to methods of determining which objects or distinguished subgraphs are live. Empty region means (310) causes all objects to be moved out from certain regions, making the region empty, so that its memory area can be reused in allocation. Gc_index updating means (311) updates the value of gc_index (priority of scheduling garbage collection for a region) when objects are allocated, freed, moved, and/or when the transitive closure computation is run. The region selection means (312) selects which regions to collect in each evacuation pause. The allocation means (313) handles allocation of memory for distinguished subgraphs from, e.g., empty regions or space vacated by freed distinguished subgraphs in partially occupied regions or holes in live distinguished subgraphs, or, e.g., using the malloc( ) or mmap( ) functions (as known in the Linux operating system, or their corresponding analogs on Windows). The freeing means (314) takes care of freeing entries and their associated distinguished subgraphs, including dealing with race conditions between copying, transitive closure, and freeing. The merging means (315) implements merging existing distinguished subgraphs (e.g., to improve locality or to reduce metadata overhead). The space tracking means (316) refers to tracking which areas of a region or a distinguished subgraph are free after a distinguished subgraph has been freed or after a subtree in it has been made inaccessible by a write.

It should be noted that the entire programming of a computer system has been presented as the program (107) in this specification. In practice, the program consists in many cases of many relatively independent components, each comprising one or more instructions executable by a processor. Some of the components may be installed, uninstalled, or upgraded independently, and may be from different vendors. The elements of this invention may be present either in the software as a whole, or in one or more of such independently installable components that are used for configuring the computing system to perform according to the present invention, or in their combination.

The boundary between hardware and software is a flexible one, and changes as technology evolves. Often, in mass-produced goods more functionality is moved to hardware in order to reduce requirements on processor performance, to reduce electrical power requirements, or to lower costs. We have already seen special cryptographic primitives being added to mainstream general-purpose processors for speeding up specific (but frequently used) cryptographic operations. Given how prevalent virtual machine based computing has become, it seems likely that certain key operations in virtual machines, including some of the garbage collection related functionality, will be implemented with special hardware operations for supporting them in the future. For example, specialized processors (or system-on-a-ship components) could be developed that implement at least parts of the garbage collection functionality in hardware (various hardware collectors were explored and produced in the 1980s, e.g. for Lisp machines and specialized logic programming machines such as in the Japanese fifth generation computing project). While in the preferred implementation the program (107) is implemented entirely in software stored on a tangible medium in a data processing device, the term “program” is intended to include also those implementations where at least parts of the garbage collector have been moved to hardware. In particular, the nursery garbage collection (especially the live object detection means (309), selection means (304), and the construction means (305)) could be implemented in hardware, as well as the distinguished subgraph copying means (306) described herein, and the closure means (307). Also, any write barrier inherent in the remset means (308) would be amenable to hardware implementation. (Other parts could also potentially be implemented in hardware.)

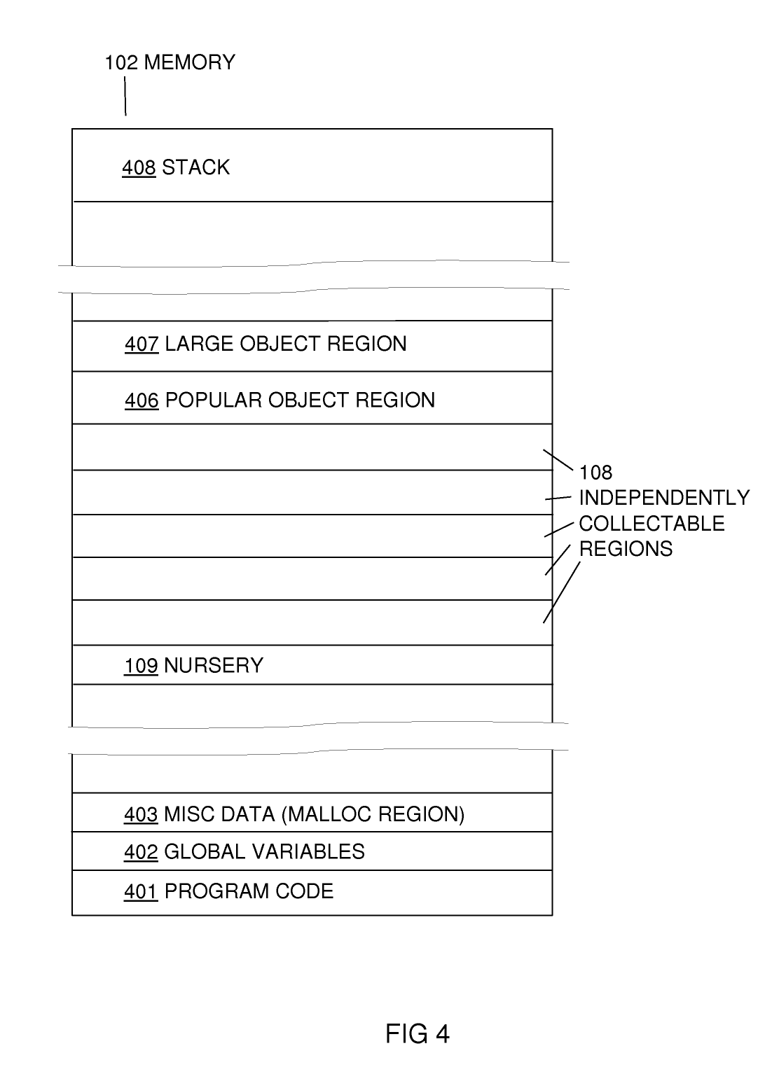

FIG. 4 illustrates an advantageous organization of the memory (102) address space of a program. The program code (401) implements the software part of the program (107), global variables (402) are global variables of the program, miscellaneous data (403) represents the memory allocated by the brk( ) function in, e.g., Linux and some malloc( ) implementations, the nursery (109) is the young object area (besides the term being used as a general designator for the area(s) from which distinguished subgraphs are constructed, here it would be a specific young object area in most embodiments, possibly comprising several distinguishable areas of relatively young objects), the independently collectable regions (108) (any number of them, from one to thousands or more) contain the distinguished subgraphs (parts of the area represented by the nursery (109) could also be collectable separately from each other, and there is no absolute requirement that the areas for storing individual objects would need to be distinct from the areas for storing distinguished subgraphs), the popular object region (406) comprises objects or distinguished subgraphs that have been selected to be considered popular (no exits are maintained for references to them, and thus they cannot easily be moved and garbage collecting them requires special methods if implemented), and the large object region (407) would typically be used to contain very large objects that would never be moved/copied. The stack (408) represents the main stack of the program; however, in practice there would usually be many stacks (one for each thread). The stack(s) may also store thread-local data.

Other important memory areas may also be present, such as those used for thread stacks, shared libraries, dynamic memory allocation, or the operating system kernel. Also, some areas may be absent or mixed with other areas (particularly the large object region and the popular object region). The order of the various memory areas may vary between embodiments.

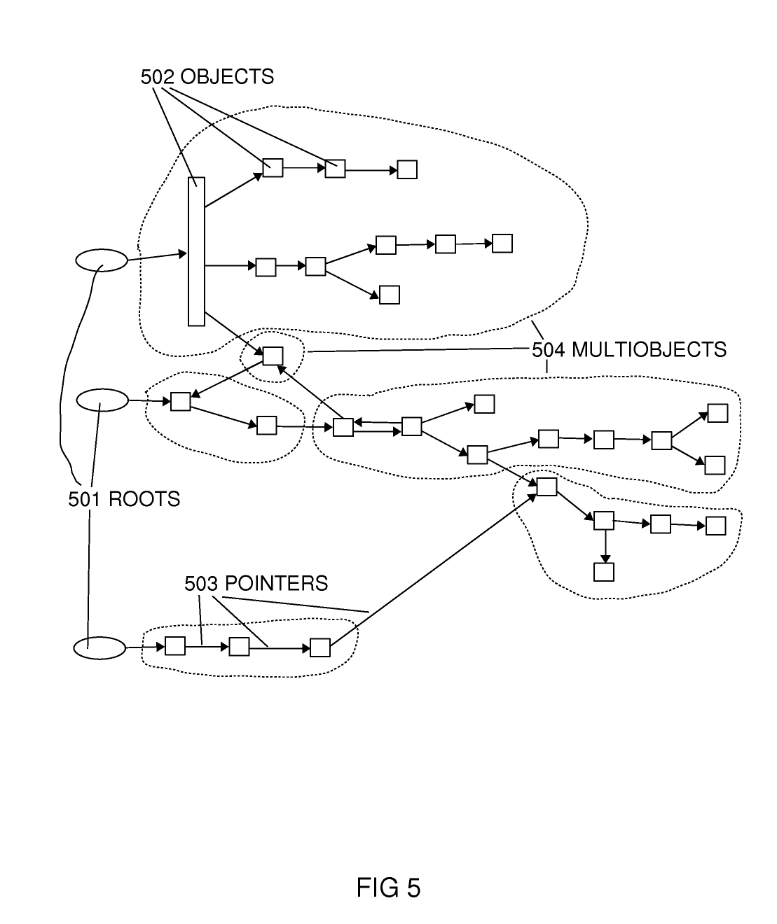

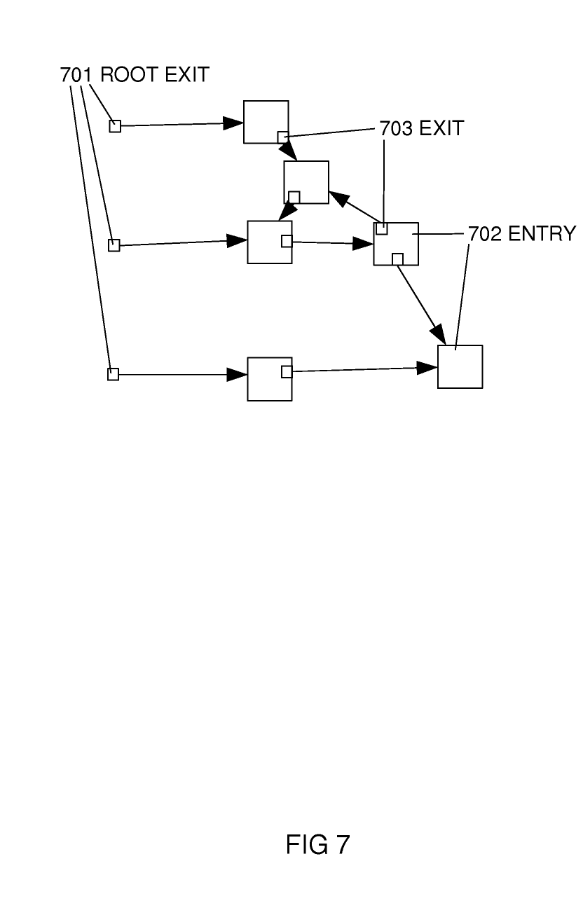

FIG. 5 illustrates dividing objects into subgraphs from which distinguished subgraphs will be constructed later. The object graph has one or more roots (501) that are intrinsically considered reachable (these typically include at least global variables, stack slots, and registers of the program; some roots, such as global variables, are permanent (though their value may change), whereas others (e.g., stack slots) can appear and disappear rapidly). In the preferred embodiment, each root is a memory cell, and at least those roots that contain a pointer preferably have an exit data structure associated with them, the exit considered intrinsically reachable (these special exits are represented by (701) in FIG. 7). The individual objects (502) (of varying sizes) form an object-level graph. Selection of which objects to group together is illustrated by the boundaries drawn with dotted lines; these are the groups from which distinguished subgraphs or multiobjects (504) will be constructed.

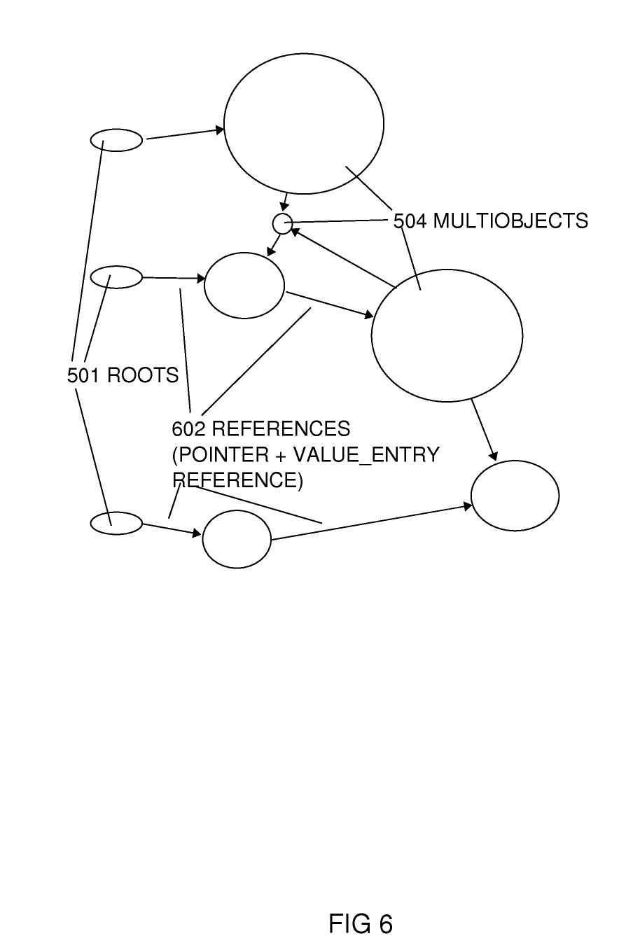

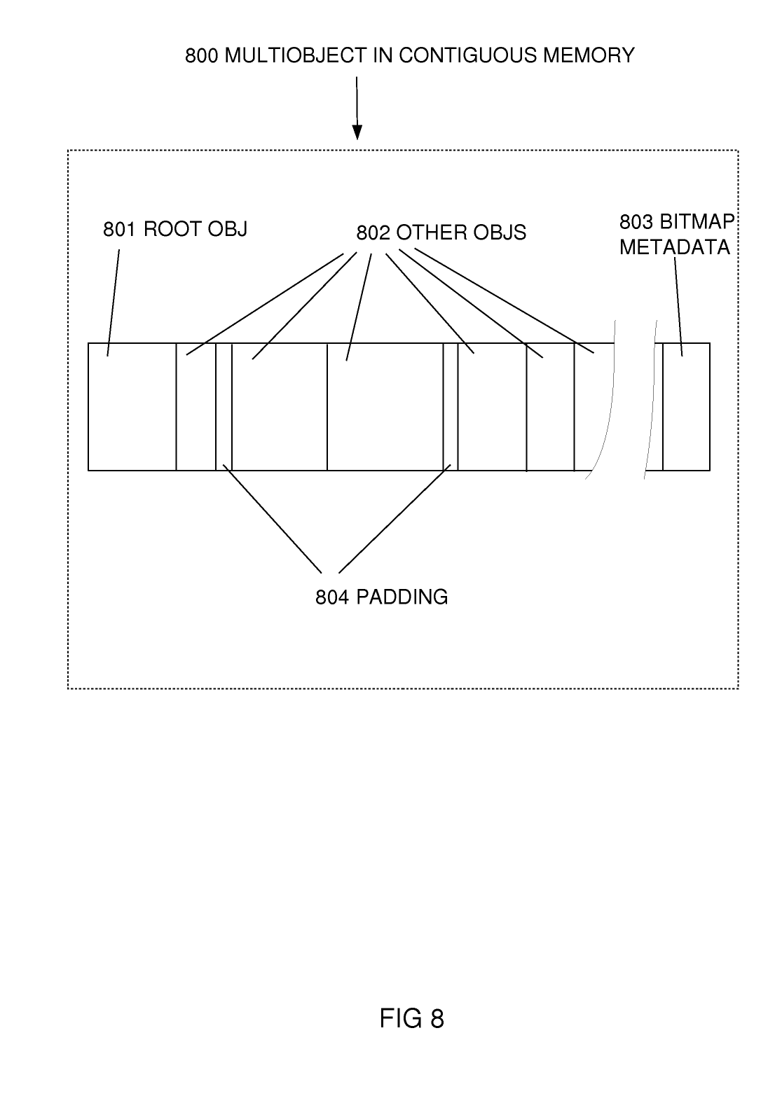

FIG. 6. illustrates the distinguished subgraphs or multiobjects constructed from the objects and groups in FIG. 5. Again, the roots are labeled by (501), and the circles represent distinguished subgraphs or multiobjects (504) in contiguous memory (see also (800) in FIG. 8). This is, in effect, a distinguished subgraph level graph for the same objects as in FIG. 5. The references (602) between multiobjects are actually represented in two ways in the preferred embodiment: as an object-level pointer (so that mutators don't need to be modified for or be aware of the implementation of garbage collector) and a remembered set level pointer.

The graph in this example was very simple, each distinguished subgraph comprising only a few objects and being structured as a tree. In practical systems, a distinguished subgraph could comprise from one to several thousand individual objects (typically many). Thus, moving from an object-level reachability graph to a distinguished subgraph level reachability graph can reduce the complexity of the graph (the number of nodes and edges) by several orders of magnitude.

FIG. 7 illustrates the remembered set structure (entries and exits) for the distinguished subgraphs in FIG. 6 in the preferred embodiment. The root exits (701) are associated each with a root containing a pointer, the entries (702) are each associated with a distinguished subgraph (though generally also objects in a young object area can have entries, and each distinguished subgraph could have more than one entry in some embodiments), and the exits (703) link entries to other entries referenced by each entry (each distinguished subgraph may comprise any number of such references, and thus multiple exits). Even though the exits are drawn within each entry in the figure, they are preferably separate data items.

FIG. 8 illustrates the preferred layout of a tree-like distinguished subgraph in a contiguous memory area (800) after it has been constructed. The distinguished subgraph begins with its root object (801), followed by other objects (802) in a specific predetermined order. The objects are stored in contiguous memory locations when the multiobject is created (except for small amounts of padding (804) typically used to ensure proper alignment), and certain metadata (803), such as a bitmap indicating which cells in the multiobject contain internal pointers (i.e., pointers pointing to non-root objects within the same multiobject).

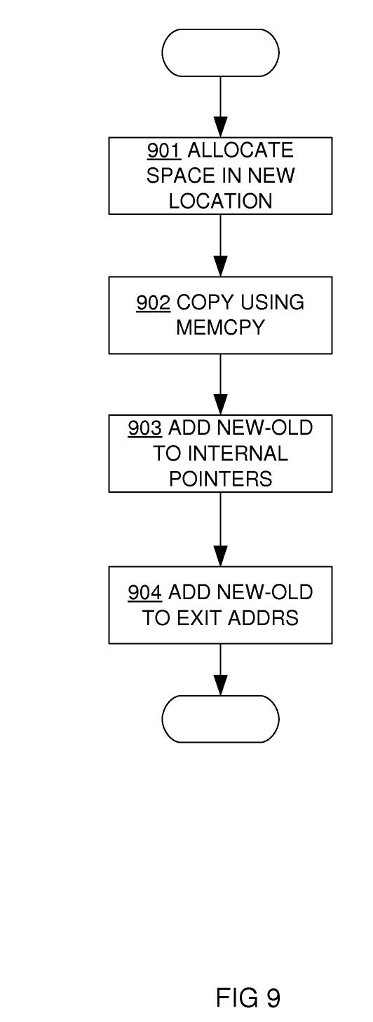

FIG. 9 illustrates ultra-fast copying of an existing multiobject using memcpy and updating its internal pointers and exits. First we allocate space for the entire multiobject (901) using its size, then copy its data to the new location using memcpy (902), add the difference of its new and old memory addresses to each cell in the new copy containing an internal pointer (903), as indicated by the metadata (803), and finally add the difference of its new and old memory addresses to the address of all exits contained in its exit tree (904). Memcpy, memmove, bcopy, array range assignment, structure assignment, and DMA are all examples of memory area copying mechanisms that can equivalently be used; read, write, send, and receive (as used in Linux) are examples of functions that can be used to copy memory between different types of memories in a data processing device.

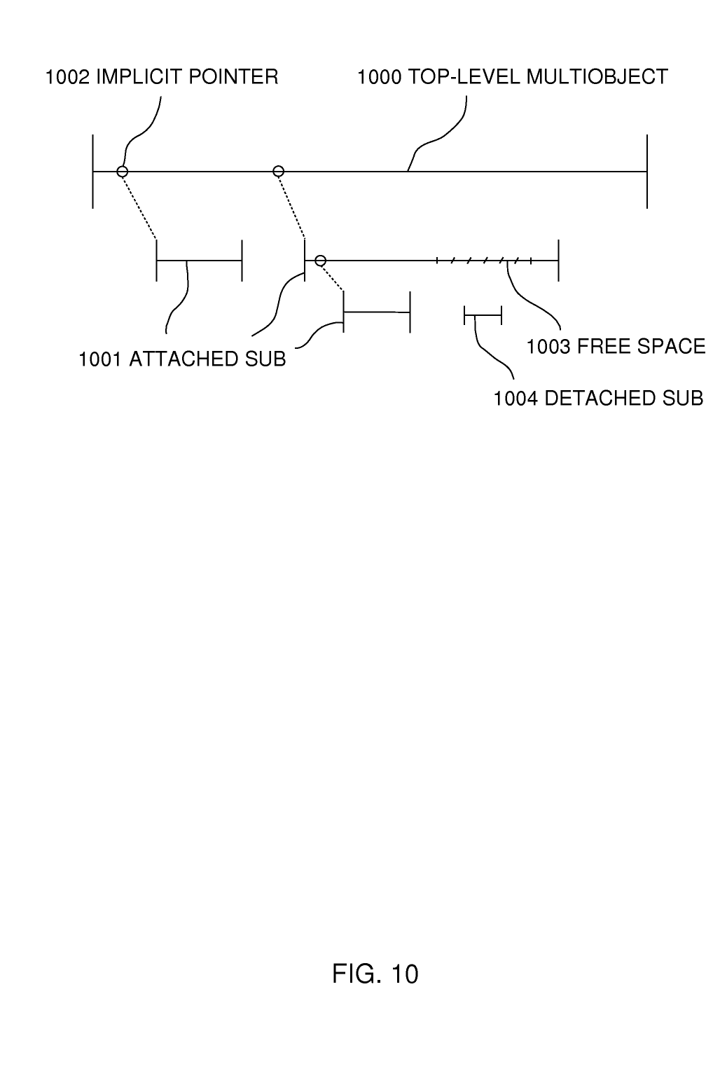

FIG. 10 illustrates a top-level multiobject with several subordinate multiobjects. In the figure, memory addresses run from left to right. (1000) illustrates the address range of the top-level multiobject. (1001) illustrate attached subordinate multiobjects. (1002) illustrates an implicit pointer contained somewhere (exact position generally not known) in the containing multiobject, in this case the top-level multiobject. (1003) illustrates space rendered inaccessible by a write to within the multiobject (somewhere outside the shaded area). (1004) illustrates a detached subordinate multiobject contained within the inaccessible space (the detached subordinate is accessible if it is still referenced from some live multiobject; however, there is no implicit pointer to it).

Even though the subordinate multiobjects are drawn here as separate lines, their data really shares the same memory addresses with their containing multiobjects. However, they will generally have separate multiobject descriptors (entries). Not shown in the figure is that any of the multiobjects may have references to them (their root objects) from the outside or from within the same multiobject(s); in the preferred embodiment, such references have “exit” objects (popular multiobjects potentially being an exception).

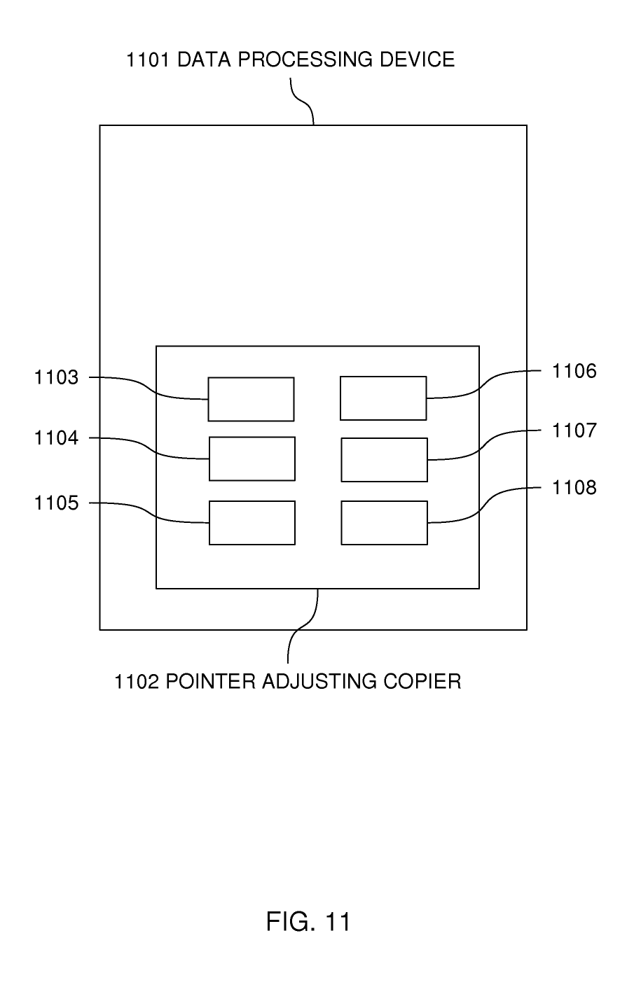

FIG. 11 illustrates a possible embodiment of a data processing device (1101) comprising a pointer adjusting memory copier (1102). Frequently, but not necessarily always, the pointer adjusting memory copier would be part of the copy means (306). The pointer adjusting memory copier comprises data read logic and buffer (1103), data write logic and buffer (1104), metadata read logic and buffer (1105), metadata bitmap accessor (1106), delta register and adder (1107), and value selector (1108). The (1103) and (1104) elements are part of normal DMA logic (typically sharing a single memory bus). The (1105) element resembles (1103), but reads metadata (some glue logic is required to arbitrate or interleave bus access between the bus-accessing elements; the implementation of such logic should be straightforward to a skilled hardware designer). (1106) reads the next bit from the metadata (it comprises a bit selector or shift register, and logic for triggering (1105) to fetch or prefetch the next word(s) of the metadata bitmap. (1107) comprises a register for holding the delta value to be added to internal pointers and an adder that adds it to the current value. (1108) selects either the current original value or the value computed by (1107), depending on the value of the current bit returned by (1106). One skilled in the art of VLSI and memory controller design can easily adapt this to various DMA controller implementation architectures, or a microprocessor architect can implement the corresponding functionality as a special instruction or microcode in a processor.

For the purposes of this disclosure, a data processing device should be interpreted broadly, as any device or system capable of performing data processing. It may, but need not necessarily be a complete computer. Basically any apparatus can be a data processing device if it can perform data processing. Examples include microprocessors, microchips, computing systems, embedded computers, supercomputers, clustered computing systems, peripherals, disk drives, robots, toys, phones, hand-held devices, wearable computers, implantable computers, telephone exchanges, and network servers. When a data processing device participates in garbage collection, it may either perform the entire garbage collection itself, or it may perform some subtasks contributing to garbage collection.

Computer program products are customarily stored on tangible media, such as CD-ROM, DVD, or magnetic disk. Frequently new copies of such computer program products are manufactured by copying the program code means embodied therein over a data communications network from a tangible source media (such as a data processing device acting as a network server, file server or a storage device) to a tangible destination media (such as a personal computer, application server, a mobile device, or a tangible memory device attached thereto). In many embodiments of the present invention, computer program products embody program code means causing a computer to participate in garbage collection and perform pointer adjusting memory copying as part of the garbage collection, and in many cases to also copy essentially contiguous distinguished subgraphs comprising more than one object without traversing individual objects therein, using a memory copy operation (such as memcpy) and updating internal pointers identified in a metadata data structure. In some cases such computer program products must be operated in a certain manner for a particular operation to be triggered.

Many variations of the above described embodiments will be available to one skilled in the art without deviating from the essence of the invention as set out herein and in the claims. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented e.g. as state machine states, logic circuits, or optics in hardware components, as instructions, subprograms or processes executed by a processor, or a combination of these and other techniques.

It is to be understood that the aspects and embodiments of the invention described herein may be used in any combination with each other. Several of the aspects and embodiments may be combined together to form a further embodiment of the invention, and not all features, elements, or characteristics of an embodiment necessarily appear in other embodiments. A method, a data processing device, or a computer program product which is an aspect of the invention may comprise any number of the embodiments or elements of the invention described herein. Separate references to “an embodiment” or “one embodiment” refer to particular embodiments or classes of embodiments (possibly different embodiments in each case), not necessarily all possible embodiments of the invention.

What is claimed is:

1. A pointer-adjusting data copying method comprising:
copying, by a data processing device, a first memory area to a second memory area; and
adjusting at least one copied memory location identified as a pointer in a metadata data structure.

2. The method of claim 1, wherein the data processing device participates in garbage collection.

3. The method of claim 1, wherein the metadata data structure is a bitmap.

4. The method of claim 1, wherein the adjusting is performed by adding to each identified pointer the difference of the starting addresses of the second and first memory areas.

5. The method of claim 1, wherein the copying is done using the memcpy function or its equivalent.

6. The method of claim 1, wherein the memory is copied before adjusting internal pointers.

7. The method of claim 1, wherein the memory is copied after adjusting internal pointers.

8. The method of claim 1, wherein the copying and adjusting steps are interlaced.

9. The method of claim 1, wherein the internal pointers are adjusted in more than one steps.

10. The method of claim 1, wherein at least one of the source and destination memory areas in copying is in non-volatile memory.

11. The method of claim 1, wherein one of the source and destination memory areas in copying is on a second node in a distributed system.

12. The method of claim 1, wherein:
the first memory area comprises an essentially contiguous distinguished subgraph comprising more than one object;
the pointers identified in the metadata data structure are the internal pointers of the distinguished subgraph; and
the copying is performed without traversing individual objects in the distinguished subgraph.

13. The method of claim 12, wherein the distinguished subgraph is a multiobject.

14. The method of claim 12, wherein the distinguished subgraph is a nested multiobject.

15. The method of claim 12, wherein the distinguished subgraph is a relaxed multiobject.

16. The method of claim 12, wherein the distinguished subgraph comprises at least one smaller distinguished subgraph.

17. The method of claim 12, further comprising:
constructing the distinguished subgraph, the constructing comprising:
dividing a plurality of objects into subsets that, together with vertices pointing between objects within each subset, are subgraphs of the object graph;
copying the objects in at least one subset into essentially consecutive memory locations;
updating internal pointers in the copied objects to point to the respective new copies of their targets; and
associating metadata with the distinguished subgraph, said metadata at least identifying which cells in the distinguished subgraph comprise internal pointers.

18. The method of claim 12, further comprising marshalling access to the distinguished subgraph using a cache coherency protocol.

19. The method of claim 12, further comprising removing holes from the distinguished subgraph.

20. The method of claim 12, further comprising combining at least one other distinguished subgraph into the distinguished subgraph.

21. The method of claim 12, further comprising swizzling or unswizzling at least one pointer in or to the distinguished subgraph.

22. A data processing device comprising:
a pointer adjusting memory copier, wherein the memory copier:
copies a first memory area to a second memory area; and
adjusts at least one copied memory location identified as a pointer in a metadata data structure.

23. The data processing device of claim 22, wherein the metadata data structure is a bitmap.

24. The data processing device of claim 22, further characterized in that it participates in garbage collection.

25. The data processing device of claim 22, wherein the adjusting is performed by adding to each identified pointer the difference of the starting addresses of the second and first memory areas.

26. The data processing device of claim 22, wherein:
the first memory area comprises an essentially contiguous distinguished subgraph comprising more than one object;
the pointers identified in the metadata data structure comprise the internal pointers of the distinguished subgraph; and
the copying is performed without traversing individual objects in the distinguished subgraph.

27. The data processing device of claim 26, wherein the distinguished subgraph is a multiobject.

28. The data processing device of claim 26, wherein the distinguished subgraph is a nested multiobject.

29. The data processing device of claim 26, wherein the distinguished subgraph is a relaxed multiobject.

30. The data processing device of claim 26, wherein the distinguished subgraph comprises at least one smaller distinguished subgraph.

31. A computer program product stored on a tangible computer-usable medium, operable to cause a data processing device to:
participate in garbage collection;
copy a first memory area to a second memory area as part of such garbage collection; and
adjust at least one copied memory location identified as a pointer in a metadata data structure.

32. The computer program product of claim 31, wherein:
the first memory area comprises an essentially contiguous distinguished subgraph comprising more than one object;
the pointers identified in the metadata data structure comprise the internal pointers of the distinguished subgraph; and
the copying is performed without traversing individual objects in the distinguished subgraph.

33. The computer program product of claim 32, wherein the distinguished subgraph is a multiobject.

34. The computer program product of claim 32, wherein the distinguished subgraph is a nested multiobject.

35. The computer program product of claim 32, wherein the distinguished subgraph is a relaxed multiobject.

36. The computer program product of claim 32, wherein the distinguished subgraph comprises at least one smaller distinguished subgraph.
